(19) United States
(12) Patent Application Publication
(10) Pub. No.: US 2026/0344726 A1
(43) Pub. Date: Nov. 5, 2026

(54) CO-DRIED FIBER PRODUCT COMPRISING A CORE OF INSOLUBLE FIBER AND AN AT LEAST PARTIAL COATING OF SOLUBLE FIBER

(71) Applicant: Cargill, Incorporated, Wayzata, MN (US)

(72) Inventors: Kim Aernouts, Emblem (BE); Abdelfattah Bensouissi, Braine-l'Alleud (BE); Mustafa Safa Ozen, Tourcoing (FR); Nick Vaes, Berlaar (BE)

(73) Assignee: Cargill, Incorporated, Wayzata, MN (US)

(21) Appl. No.: 19/484,959

(22) PCT Filed: Apr. 26, 2024
(86) PCT No.: PCT/US2024/026381

§ 371 Date: Nov. 17, 2025

(30) Foreign Application Priority Data
May 25, 2023 (EP) 23175447.4

(51) Int. Cl. A23L 33/22; A23G 1/40; A23G 1/48; A23P 10/22

(52) U.S. Cl. CPC A23L 33/22; A23G 1/40; A23G 1/48; A23P 10/22

(57) ABSTRACT

The present invention relates to co-dried fiber products comprising soluble fibers and insoluble fibers. The present invention further relates to methods for preparing such co-dried fiber products, as well as fat-based foods or feed products comprising the co-dried fiber products. The present invention also relates to uses of co-dried fiber products as bulking agents or sugar replacement in fat-based foods or feeds.

### CROSS-REFERENCE TO RELATED APPLICATIONS

This application claims the benefit of European Application No. 23175447.4, filed May 25, 2023, which is hereby incorporated by reference in its entirety.

### FIELD OF THE INVENTION

The present invention relates to co-dried fiber products comprising soluble fibers and insoluble fibers. The present invention further relates to methods for the production of such co-dried fiber products, as well as fat-based foods or feeds comprising the co-dried fiber products.

### BACKGROUND

Insoluble fibers are frequently used as bulking agents in various food or feed products, in particular in fat-based food and feed products.

Moreover, insoluble fibers also serve as sugar replacers in various food and feed products such as chocolate products with the purpose of reducing the calories of such products.

However, the use of insoluble fibers may come with various disadvantages. For example, when insoluble fibers are used in fat-based food products, undesired rheological properties of the products such as an undesirable increase of the viscosity and/or the yield stress may be resulted. To overcome such increase of rheology, an additional fat addition is in general required and this results in an undesirable increase of calories and price.

Moreover, the use of insoluble fibers in fat-based products may lead to undesired sensorial properties, such as a decrease of the sweetness and the development of off-tastes.

The present invention is directed to the provision of fiber products comprising insoluble fibers that do not show the above-mentioned disadvantages or at least represent an improvement as compared to existing solutions.

### BRIEF DESCRIPTION OF THE FIGURES

FIG. 1 shows an electron microscopy image of Resistant dextrin fiber (CSF).

FIG. 2A shows an electron microscopy image of micronized wheat bran (MWB).

FIG. 2B shows an electron microscopy image of a dry blend of micronized wheat bran and resistant dextrin fiber (MWB/CSF (dry blend)).

FIG. 2C shows an electron microscopy image of a co-dried micronized wheat bran and resistant dextrin fiber (MWB/CSF (SD).

FIG. 3A shows an electron microscopy image of corn fiber (Fibrogem).

FIG. 3B shows an electron microscopy image of a dry blend of com fiber and resistant dextrin fiber (Fibrogem/CSF (dry blend)).

FIG. 3C shows an electron microscopy image of a co-dried corn fiber and resistant dextrin fiber (Fibrogem/CSF (SD)).

FIG. 4A shows an electron microscopy image of sunflower meal (LoPro).

FIG. 4B shows an electron microscopy image of a dry blend of sunflower meal and resistant dextrin fiber (LoPro/CSF (dry blend)).

FIG. 4C shows an electron microscopy image of a co-dried sunflower meal and resistant dextrin fiber (LoPro/CSF (SD)).

FIG. 5 shows a plot of yield stress values (Pa) for chocolate products comprising soluble fibers only (CSF only), co-dried MWB/CSF (MWB/CSF (SD)), dry blended MWB/CSF (MWB/CSF (dry blend)), or insoluble fibers only (MWB only), and the reference chocolate product.

FIG. 6 shows a plot of yield stress values (Pa) for chocolate products comprising soluble fibers only (CSF only), co-dried LoPRO/CSF (LoPRO/CSF (SD)), dry blended LoPRO/CSF (LoPRO/CSF (dry blend), or insoluble fibers only (LoPRO only), and the reference chocolate product.

FIG. 7 shows a plot of viscosity values (Pa·s) for chocolate products comprising soluble fibers only (CSF only), co-dried MWB/CSF (MWB/CSF (SD)), dry blended MWB/CSF (MWB/CSF (dry blend)), or insoluble fibers only (MWB only), and the reference chocolate product.

FIG. 8 shows a plot of viscosity values (Pa·s) for chocolate products comprising soluble fibers only (CSF only), co-dried Fibrogem/CSF (Fibrogem/CSF (SD)), dry blended Fibrogem/CSF (Fibrogem/CSF (dry blend)), or insoluble fibers only (Fibrogem only), and the reference chocolate product.

FIG. 9 shows a plot of sensorial evaluations for various chocolate compositions with regard to sweetness.

FIG. 10 shows a plot of sensorial evaluations for various chocolate compositions with regard to sweetness perception.

FIG. 11 shows a plot of sensorial evaluations for various chocolate compositions with regard to off-tastes.

### SUMMARY OF THE INVENTION

The present invention relates to a co-dried fiber product comprising soluble fibers and insoluble fibers, in which the insoluble fibers are partially or fully coated with soluble fibers.

The present invention further relates to a method for the preparation of the co-dried fiber product according to the invention, wherein the method comprises the steps of: (a) mixing soluble fiber particles and insoluble fiber particles in a dry weight ratio of from 20:80 to 80:20, preferably from 30:70 to 70:30, more preferably from 40:60 to 60:40, even more preferably of 50:50, in water to obtain a suspension; (b) drying the suspension, preferably by spray-drying, to obtain a co-dried fiber product; and (c) optionally adding one or more of the following to the co-dried fiber product: flavoring agents, emulsifying agents, coloring agents, and anticaking agents. The insoluble fibers are partially or fully coated with the soluble fibers in the co-dried fiber product.

The present invention further relates to a co-dried fiber product obtainable by the method according to the invention.

The present invention further relates to a fat-based food or feed product comprising the co-dried fiber product according to the invention.

The present invention further relates to a use of the co-dried fiber product as a bulking agent or sugar replacement in a fat-based food or feed product.

### DETAILED DESCRIPTION

Reference will now be made in detail to certain aspects of the disclosed subject matter, examples of which are illustrated in part in the accompanying figures. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are on a by weight basis. Percentage on a by weight basis is also referred to as wt. % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, “room temperature” or “RT” refers to a temperature between 20 °C and 25 °C.

### Co-Dried Fiber Product

The present invention relates to a co-dried fiber product comprising soluble fibers and insoluble fibers, wherein the insoluble fibers are partially or fully coated with soluble fibers.

The term “co-dried” describes that the fiber product has been obtained by drying an aqueous suspension of soluble fibers and insoluble fibers. It further describes that the soluble fibersand insoluble fibers have been dried at the same time, i.e., within one process step. Optionally, the co-dried powder is cooled down below 50 °C, milled, sieved, classified, and/or mixed with additional ingredients such as colorants, flavors, and the like.

The term “coated” means that one or more soluble fibers are present on and/or adhered to at least a surface of an insoluble fiber. A “surface of an insoluble fiber” means an exterior face of the insoluble fiber. An insoluble fiber may be partially or fully coated with one or more soluble fibers. Preferably, an insoluble fiber is fully coated with soluble fibers.

Preferably, an insoluble fiber coated with one or more soluble fibers may be produced by co-drying the insoluble fibers and soluble fibers. In this regard, an insoluble fiber co-dried with one or more soluble fibers would be equivalent to an insoluble fiber coated with one or more soluble fibers.

The term “partially coated” means that one or more soluble fibers are present on and/or adhered to at least 1%, from 1 to 10%, from 10 to 20%, from 20 to 30%, from 30 to 40%, from 40 to 50%, from 50 to 60%, from 60 to 70%, from 70 to 80%, from 80 to 90% from 90 to 99%, or at most 99% of the surfaces of an insoluble fiber.

The term “fully coated” means that one or more soluble fibers are present on and/or adhered to all the surfaces of an insoluble fiber, i.e., the insoluble fiber is completely encapsulated by the soluble fibers.

The terms “soluble fiber” and “insoluble fiber” are well known to a skilled person. In this regard, a “soluble fiber” is a fiber that dissolves in water, in particular at room temperature (e.g., 20 °C). By contrast, an “insoluble fiber” is a fiber that does not dissolve in water, in particular at room temperature (e.g., 20 °C).

In an aspect, the co-dried fiber product of the present invention may include a combination of soluble fibers and insoluble fibers, in which the insoluble fibers are partially or fully coated with soluble fibers. Preferably, the co-dried fiber product comprises three species of fibers, in which a first species of fibers are soluble fibers that are not bound to any insoluble fibers (free soluble fibers), a second species of fibers are insoluble fibers that are not coated with any soluble fibers (free insoluble fibres), and a third species of fibers are insoluble fibers that are partially or fully coated with soluble fibers.

In one aspect, the co-dried fiber product of the present invention may include soluble fibers and insoluble fibers, in which the insoluble fibers are fully coated with the soluble fibers.

In another aspect, the co-dried fiber product of the present invention may include soluble fibers and insoluble fibers, in which the insoluble fibers are partially coated with the soluble fibers.

In a further aspect, the co-dried fiber product of the present invention may include soluble fibers and insoluble fibers, in which a first portion of the insoluble fibers are fully coated with the soluble fibers, and a second portion of the insoluble fibers are partially coated with the soluble fibers. Preferably, a ratio of partially coated insoluble fibers to fully coated insoluble fibers is from 10:90 to 90:10, from 20:80 to 80:20, from 30:70 to 70:30, from 40 to 60 to 60:40, or 50:50 in the co-dried fiber product.

In one aspect, the dry weight ratio of soluble to insoluble fibers in the co-dried fiber product is from 10:90 to 90:10, from 20:80 to 80:20, from 30:70 to 70:30, from 40:60 to 60:40, or 50:50.

In an aspect, the co-dried fiber product of the present invention may include soluble fibers and insoluble fibers, in which all the insoluble fibers are partially or fully coated with the soluble fibers.

In one aspect, the co-dried fiber product of the present invention may include soluble fibers and insoluble fibers, in which at least a portion of the insoluble fibers are partially or fully coated with the soluble fibers.

In an aspect, the co-dried fiber product of the present invention may include a blend of insoluble fibers that are co-dried with soluble fibers (co-dried fibers), and insoluble fibers that are not co-dried with soluble fibers. Preferably, the co-dried fiber product may include a blend that comprises, based on the total weight of the blend, co-dried fibers in an amount of from 1 to 99 wt. %, with the remaining amount being soluble and insoluble fibers that are not co-dried together.

The co-dried fiber product has a moisture content of, based on the total weight of the co-dried fiber product, from 1 to 10 wt. %, preferably from 3 to 8 wt. %, more preferably 5 to 7 wt. %.

Non-limiting examples of “insoluble fiber” that may be used in accordance with the present invention are dietary fibers, corn fibers, sun flower meals, cereal brans, oat fibers, bamboo fibers, fruit fibers, sugar beet fibers, sugar cane fibers, tomato fibers, coconut fibers, straws from cereals such as wheat or barley, pea fiber, tea, coffee, potato fiber, cocoa, cocoa powder, bran waste, sugar waste, cocoa waste, corn-cob waste, cellulose, hemi-cellulose (for example from elephant grass), chitosan, pectins, gums, mucilages, lignins, compositions comprising the same or combinations thereof. Insoluble fibers, such as wheat bran, can be obtained in micronized form having reduced particle size, for use in the present invention.

Non-limiting examples of “soluble fiber” that may be used in accordance with the present invention are resistant dextrin, (such as Promitor® grades from Tate & Lyle, Nutriose® grades from Roquette, and Fibersol® grades from ADM/Mitsutani, resistant/modified maltodextrin), polydextrose (such as Litesse®), β-glucan, galactomannan, fructo-oligosaccharides, gluco-oligosaccharide, galacto-oligosaccharides, MOS (mannose-oligosaccharides, also known in the art as mannan-oligosaccharides or manno-oligosaccharides), monosaccharides (such as glucose, fructose, galactose, xylose, and ribose), pectin, psyllium, inulin, resistant starch, xylo-oligosaccharides, compositions comprising the same or combinations thereof. The soluble fiber may for example be Nutriose® from Roquette. The resistant dextrin or polydextrose can also be obtained according to the process described in WO2011/091962, which is incorporated herein by reference. The soluble fiber can also be a MOS obtainable according to the processes described in WO2018/232078, which is incorporated herein by reference.

Preferably, the soluble fiber is selected from the group consisting of resistant dextrin fiber (e.g., corn soluble fiber and wheat soluble fiber), and the insoluble fiber is selected from the group consisting of wheat brans, corn fibers, and sun flower meals.

Non-limiting examples of “flavoring agent” that may be used in accordance with the present invention are high intensity sweeteners (such as natural intense sweeteners and artificial intense sweeteners).

### Particle Size Distribution

In one aspect, the co-dried fiber product has a D10 of less than 10 μm, preferably from 1 to 10 μm, or more preferably from 3 to 8 μm. The co-dried fiber product has a D50 of less than 60 μm, preferably in a range of from 1 to 60 μm, or more preferably in a range of from 10 to 30 μm. The co-dried fiber product has a D90 of less than 150 μm, preferably in a range of from 20 to 150 μm, or more preferably in a range of from 30 μm to 80 μm.

Preferably, the co-fried fiber product has a D10 of less than 10 μm, a D50 of less than 60 μm, and a D90 of less than 150 μm.

The term “D10” refers to a particle size distribution parameter which signifies a size distribution at which 10% of the total particles are smaller than this size.

The term “D50” refers to a particle size distribution parameter which signifies a size distribution at which 50% of the total particles are smaller than this size.

The term “D90” refers to a particle size distribution parameter which signifies a size distribution at which 90% of the total particles are smaller than this size.

The particle size distribution may be measured by laser light diffraction, for example using a Mastersizer 3000 system (Malvern). This equipment allows the measurement of particles with sizes ranging from 0.1 to 3,500 μm. The system includes a:
Helium Neon red laser (633 nm, max 4 mW) along with a 10 mW 470 nm blue LED light source and a wide angle detection system (0.015 to 144 degrees)·
Hydro MV medium volume automated liquid sample dispersion unit or Hydro SM manual liquid sample dispersion unit for measurements in liquid (oil, solvents, or water)· Aero S automated dry powder dispersion system with a venturi disperser.

Prior to sample measurement, a background measurement (duration of 10 seconds or longer) may be carried out.

Preferred settings for measurements are:
Particle type: non-spherical
Particle optical parameters: Refractive index (RI) and Absorption index (AI) of the sample.
Calculation: Mie theory
Optical parameters of background medium: Refractive index (RI) and Absorption index (AI) of the medium: Air for powder measurement, dispersant for measurements in liquid.

As mentioned earlier, the machine is equipped with two different modules enabling the measurement of particles size distribution in dry or dispersed in liquid. The choice of the method (dispersion in air or in liquid) depends on the particles' capability to disperse in air or in a liquid. The choice of the dispersion media should not affect the size and/or the shape of the particles. In the present invention the dispersion mediums used are air in the case of the Aero S module and oil in the case of the Hydro SM module.

Preferred settings of the measurement with the Aero S module are:
Feed rate: 0 to 100% (optimized to obtain obscuration range 0.5 to 15%)
Air pressure: 0 to 3 bar
Obscuration: range 0.5 to 8% obscuration
Amount of sample: 1 to 20 g of sample is added to the venturi dispenser.
Measurement duration: time needed to measure the whole sample that was added to the venturi dispenser

Settings of the measurement with the Hydro SM module are:
Obscuration: range 2 to 20%-Sample is added to the liquid sample dispersion unit until the obscuration is in range (See Table 1)
Stirring speed: 1,000 to 3,000 rpm
Measurement duration: 10 seconds or longer

TABLE 1
Obscuration settings for Mastersizer 3000 system

| SIZE | OBSCURATION |
|---|---|
| very fine (<1 μm) | <5% |
| fine (1 to 100 μm) | 5-10% |
| coarse (1000 μm) | 10-20% |
| very polydisperse (>1000 μm) | 10-20% |

The volumetric particle size distribution is calculated from the intensity profile of the scattered light with the Mie theory by use of the software accompanying the machine. The following parameters, among others, are automatically generated by the software:
D [v,0.1]: is the volume diameter where 10% of the volume distribution is below this value (D [v,0.1]). This is the D10 particle size in accordance with the present invention.
D [v,0.5]: is the volume median diameter where 50% of the volume distribution of the particles is above and 50% is below this value (D [v,0.5]). This is the D50 particle size in accordance with the present invention.
D [v,0.9]: is the volume diameter where 90% of the volume distribution is below this value (D [v,0.9]). This is the D90 particle size in accordance with the present invention.

In one aspect, the median particle size of the co-dried fiber product is increased by 20% to 90% as compared to the insoluble fiber particles, preferably by 30% to 80% as compared to the insoluble fiber particles, more preferably by 50% to 80% as compared to the insoluble fiber particles.

Under “as compared to insoluble fiber particles”, it is meant the comparison of the median particle size of the co-dried fiber product of the present invention with a situation when insoluble fiber particles would have been dried alone, i.e., being dried in the absence of soluble fibers.

### Oil Binding Capacity

The term “oil binding capacity” (OBC) refers to a measurement of the amount of oil that a substance or a product can retain (bind) per gram of sample. Having a co-dried fiber product with an optimum OBC is important for food or beverage products because the OBC affects the rheology and hardness thereof: If an OBC value is too high, the resulting product will have an undesirable hard texture. In contrast, if an OBC value is too low, there will be oil oozing out of the product. In particular, this phenomenon relates to confectionary products containing fat.

The oil binding capacity of the co-dried fiber product is from 0.7 to 1.45 g oil/g of co-dried fiber product, preferably from 0.9 to 1.35 g oil/g of co-dried fiber product. More preferably, the oil binding capacity is from 1.1 to 1.35 g oil/g of co-dried fiber product.

The oil-binding capacity (OBCOBC) is expressed as the amount of oil (g) that can be bound by per gram of co-dried fiber product and is thus calculated by the following formula:

OBCOBC=W_{CO}/W_{CP},
wherein W_{CO} refers to the amount of bound oil (g), and
wherein W_{CP} refers to the amount of co-dried fiber product.

The oil-binding capacity (OBCOBC) may be determined as follows:
preparing a dispersion of co-dried fiber product in soya oil (W1 is the amount of co-dried fiber product, and W2 is the amount of soya oil);
stirring the mixture (e.g., for 10 minutes at 500 rpm) until the co-dried fiber product is completely dispersed in the soya oil;
allowing the mixture to stand at room temperature (e.g., for 30 minutes) until the mixture is adapted to the hygrophobicity;
stirring the dispersion and filling a certain amount of product-in-oil dispersion in a tube (W3 is the weight of the tube and W4 is the total weight of the tube after addition of the product-in-oil dispersion);
centrifuging the tube (e.g., for 5 minutes at 3,800 rpm) for example with a Sorvall Automatic centrifuge SS-3; and
decanting the supernatants and weighing the centrifuging tube containing the precipitate (W5).

The oil-binding capacity (OBC) can then be determined as follows:

OBC=W_{CO}/W_{CP},
wherein Wₚ is the percentage amount of product in the start oil mixture: Wₚ=W1×100/(W1+W2);
wherein W_{O} is the percentage amount of oil in the start oil mixture: W_{O}=W2×100/(W1+W2);
wherein W_{CP} is the product weight: W_{CP}=(Wₚ/100)×(W4−W3); and
wherein W_{CO} is the oil bind: W_{CO}=W5−W3−W_{CP}.

In one aspect, the oil binding capacity of the co-dried fiber product is decreased by 1% to 50% as compared to the insoluble fiber particles, preferably by 3% to 40% as compared to the insoluble fiber particles, more preferably by 5% to 30% as compared to the insoluble fiber particles.

Under “as compared to insoluble fiber particles”, it is meant the comparison of the oil binding capacity of the co-dried fiber product of the present invention with a situation when corresponding insoluble fiber particles would have been dried alone, i.e., being dried in the absence of soluble fibers.

### Method for Preparing Co-Dried Fiber

The present invention relates to a method for the preparation of the co-dried fiber product of the present invention, wherein the method comprises the steps of:
(a). mixing soluble fiber particles and insoluble fiber particles in a dry weight ratio of from 20:80 to 80:20, preferably from 30:70 to 70:30, more preferably from 40:60 to 60:40, even more preferably of 50:50, in water to obtain a suspension;
(b). drying the suspension, preferably by spray-drying, to obtain a co-dried fiber product; and
(c). optionally adding one or more of the following to the co-dried fiber product: flavoring agents, emulsifying agents, coloring agents, and anticaking agents.

In the co-dried fiber product, the insoluble fiber particles are partially or fully coated with the soluble fiber particles.

In the drying step, the soluble fiber particles and the insoluble fiber particles present in the suspension are co-dried in a drying system known in the art that may include, but not limited to, spray dryer, fluid bed dryer, vacuum belt reactor, vacuum dryer, and the like. In one aspect, any drying system that involves a spraying module without exposing the product to high temperature and/or long drying time can be used in the present invention. Optionally, the co-dried fiber product obtained from the drying step can be cooled below a glass transition temperature, sieved and/or classified, and partially milled to adapt to the particle size distribution.

Preferably, the drying step is performed by spray-drying. The inlet temperature of the spray dryer is from 130 to 180 °C, preferably from 140 to 170 °C, more preferably from 150 to 160 °C. The outlet temperature of the spray dryer is from 70 to 100 °C, preferably from 80 to 90 °C.

Preferably, the drying step is performed by spray-drying, wherein the inlet temperature of the spray dryer is from 130 to 180 °C and the outlet temperature of the spray dryer is from 70 to 100 °C.

In one aspect, the mixing step can further include steps of: (d). dissolving soluble fiber particles with water having a temperature of from 5 to 95 °C, preferably from 30 to 85 °C, more preferably from 60 to 80 °C, to form a soluble fiber solution; and (e). adding insoluble fiber particles into the soluble fiber solution to obtain the suspension of soluble and insoluble fiber particles.

In another aspect, insoluble fiber particles can be added first to the water, followed by the addition of soluble fiber particles. Under such circumstances, the mixing step can then include steps of: (d). dispersing insoluble fiber particles with water having a temperature of from 5 to 95 °C, preferably a temperature of from 30 to 85 °C, more preferably from 60 to 80 °C, to form an insoluble fiber mixture; and (e). adding soluble fiber particles into the insoluble fiber mixture to obtain the suspension of soluble and insoluble fiber particles.

The mixing step and the drying step of the method may be carried out in one single step or separate steps.

Any or all (e.g., two or more) of the method steps of: mixing soluble fiber particles and insoluble fiber particles in a dry weight ratio of from 20:80 to 80:20, preferably from 30:70 to 70:30, more preferably 40:60 to 60:40, even more preferably 50:50, in water to obtain a suspension; drying the suspension, preferably by spray-drying, to obtain a co-dried fiber product; and/or optionally adding one or more of the following to the co-dried fiber product: flavoring agents, emulsifying agents, coloring agents, and anticaking agents, may occur simultaneously, sequentially, or non-sequentially. For example, all of these steps may be carried out simultaneously in a dryer, such as a spray dryer. One or more of the steps may be repeated.

In another aspect, the present invention relates to a co-dried fiber product obtainable by the method of the present invention.

### Applications—Food or Feed Products

In another aspect, the present invention relates to a fat-based food or feed product comprising the co-dried fiber product of the present invention. This relates to both, the co-dried fiber product described above as well as the co-dried fiber product obtained by the method of the present the invention.

In one aspect, the fat-based food or feed product has a fat content of higher than 20 wt. %, preferably higher than 30 wt. %, based on the total weight of the fat-based food or feed product. Preferably, the fat-based food or feed product has a fat content of from 20 to 50 wt. %, preferably of from 30 to 40 wt. %, more preferably of from 32 to 35 wt. % based on the total weight of the fat-based food or feed product.

In one aspect, the fat-based food or feed product comprises less than 40 wt. % of sugars, preferably from 25 to 35 wt. % sugars, more preferably from 25 to 30 wt. % sugars, based on the total weight of the fat-based food or feed product.

In one aspect, the co-dried fiber product of the present invention is present in the fat-based food or feed product in an amount of from 1 to 25 wt. %, preferably from 5 to 23 wt. %, more preferably from 10 to 22 wt. %, even more preferably from 15 to 20 wt. %, based on the total weight of the fat-based food or feed product.

### Rheology

In one aspect, yield stress of the fat-based food or feed product is from 0.3 to 15 Pa, preferably from 0.4 to 10 Pa, more preferably from 0.5 to 5 Pa. Preferably, the yield stress is measured according to the IOCCC2000 standard at a temperature of 40 °C and at a pre-shear rate of 5 s⁻¹ for 60 s, a shear rate-ramp from 2 s⁻¹ to 50 s⁻¹ for 180 s, a holding phase of 60 s at a shear rate of 50 s⁻¹, and a shear rate-ramp from 50 s⁻¹ to 2 s⁻¹ for 180 s. Preferably, the yield stress is calculated according to the Casson method. The Casson equation is as follows:

√τ=√τ₀+√(η·γ) Casson equation:

wherein: γ=shear rate; τ=shear stress; τ₀=Casson yield value; and η=Casson viscosity.

In one aspect, the yield stress of the food or feed product having the co-dried fiber product is decreased by 55 to 85%, preferably from 60 to 80%, more preferably from 65 to 75% as compared to the food or feed product having only the insoluble fibers.

Under “as compared to the food or feed product having only the insoluble fibers”, it is meant that the comparison of the yield stress of the food or feed product having the co-dried fiber product of the present invention with a situation when corresponding insoluble fibers would have been dried alone in the preparation of the food or feed product, i.e., being dried in the absence of soluble fibers.

In one aspect, viscosity of the fat-based food or feed product is from 0.5 to 2.5 Pa·s, preferably from 0.8 to 2.2 Pa·s, more preferably from 1.0 to 2.0 Pa·s. Preferably, the viscosity is measured according to the IOCCC2000 standard at a temperature of 40 °C and at a pre-shear rate of 5 s⁻¹ for 60 s, a shear rate-ramp from 2 s⁻¹ to 50 s⁻¹ for 180 s, a holding phase of 60 s at a shear rate of 50 s⁻¹, and a shear rate-ramp from 50 s⁻¹ to 2 s⁻¹ for 180 s. Preferably, the viscosity is calculated according to the Casson method as mentioned above.

In one aspect, the viscosity of the food or feed product having the co-dried fiber product is decreased by 20 to 60%, preferably from 25 to 55%, more preferably from 30 to 50% as compared to the food or feed product having only the insoluble fibers.

Under “as compared to the food or feed product having only the insoluble fibers”, it is meant that the comparison of the viscosity of the food or feed product having the co-dried fiber product of the present invention with a situation when corresponding insoluble fibers would have been dried alone in the preparation of the food or feed product, i.e., being dried in the absence of soluble fibers.

For the rheological measurements (yield stress and viscosity), rheometers from the company Anton Paar may be used (model MCR 51 or model MCR 72).

It is known in the art that the limitations of using insoluble fibers include increasing rheological properties such as viscosity and yield stress of the resulting food or feed products, and producing off taste. It has surprisingly been found in this invention that the use of insoluble fibers coated with soluble fibers (i.e., insoluble fibers co-dried with soluble fibers) in food or feed products provides at least the following advantages: improving taste and mouthfeel, removing off taste, reducing viscosity and yield stress of the food or feed product, fiber enrichment, calories reduction, and reduction of nutriscore.

The fat-based food or feed product can be selected from the group consisting of a confectionary product, a culinary product, a dairy product, a nutritional formula, a breakfast cereal (including flapjacks, cereal bars, and extruded cereal based products and co-extruded filled cereal based products), a baked product, and/or animal food. Confectionary products are foodstuffs which are predominately sweet in flavour and are not predominately baked. Exemplary confectionary products may include, but may not be limited to, fat-based confectionary products (such as chocolate, chocolate-like material, and fat-continuous filling material), and frozen confectionary (such as ice cream and combinations thereof, for instance chocolate coating of frozen confectionary or chocolate pieces within frozen confectionary). Further examples of confectionary products may include, but may not be limited to, fondant, ganache, and the like. Baked products are, or comprise components which are, predominately baked and may be sweet or savory and may comprise baked grain foodstuffs. Exemplary baked products may comprise baked cereals and/or pulses such as baked wheat foodstuffs (such as bread, rolls, cakes, pastries, crumpets, scones, pancakes, pies, gingerbreads, biscuits, wafers, cookies, and the like). The food product of the present invention may be the entire food product or it may part of a food product such as a filling, a binder, a shell or coating, an inclusion, or a decoration for a food product. The food product may also be a multi-layered foodstuff optionally comprising a plurality of layers of baked foodstuff, wafer or biscuit, and at least one filling layer located between the layers of baked foodstuff, wafer or biscuit, where the filling layer may comprise a fat based confectionery composition. Any combination of the above alternatives is also encompassed by the present invention.

Advantageously, the fat-based food or feed product has a relatively low water content, such as from 1 to 10 wt. %, 3 to 8 wt. %, 5 to 7 wt. %. Preferably, the food or feed product has a water content of 6 wt. % or less, 5 wt. % or less, 4 wt. % or less, 3 wt. % or less, 2 wt. % or less, or 1 wt. % or less.

Preferably, the fat-based food or feed product is a chocolate product.

In one aspect, the present invention relates to the use of a co-dried fiber product of the present invention as a bulking agent or sugar replacement in a fat-based food or feed product.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1—Preparation of Co-Dried Products According to the Invention

Co-dried fiber product samples 1 to 3 were prepared as follows:

Soluble fibers were weighted into a plastic bucket and mixed with water, which was preheated to 70 °C, with an Ultra turrax device to form a soluble fiber solution. Insoluble fibers were weighted and added to the soluble fiber solution while mixing with an Ultra turrax device. Finally, the obtained suspension was spray-dried using an inlet temperature between 150 to 160 °C and an outlet temperature between 80 to 90 °C. The dry powder was immediately cooled below 35 to 40 °C and sieved to avoid formation of lumps. The amounts of soluble and insoluble fibers as well as amounts of water used for samples 1 to 3 are indicated in Table 1 below.

TABLE 1
Types and amounts of insoluble/soluble fibers used
for Samples 1 to 3 as well as amounts of water.

| | Sample 1 | Sample 2 | Sample 3 |
|---|---|---|---|
| Insoluble fiber (IF) | Micronized wheat | Corn fiber | Sun flower meal |
| | bran | (Fibrogem B+ from | (LoPro from Cargill) |
| | (Cargill) | Cargill) | |
| Moisture content | 3.63 | 4.53 | 4.44 |
| Amount IF (g) | 600 | 600 | 386 |
| Soluble fiber (SF) | Resistant dextrin | Resistant dextrin fiber | Resistant dextrin fiber |
| | fiber | (CSF L80 from | (CSF L80 from |
| | (CSF L80 from | Cargill) | Cargill) |
| | Cargill) | | |
| Moisture content | 74.90 | 74.90 | 74.90 |
| Amount SF (g) | 772 | 765 | 493 |
| Amount water (g) | 2,137 | 3,224 | 2,077 |
| Total suspension (g) | 3,509 | 4,589 | 2,955 |

### Particle Size Distribution

The particle size distributions of samples 1 to 3 were measured with a Malvern particle size analyzer (Mastersizer 3000). Moreover, the particles size distributions measured for samples 1 to 3 were compared with the particle size distributions of the soluble fibers (CSF) and insoluble fibers (MWB, CF, and SFM) that were used for the preparation of samples 1 to 3. The results are given in Table 2 below.

TABLE 2
Particle size distributions of samples 1 to 3,
soluble fibers, and insoluble fibers.

| Type of fiber | | | |
|---|---|---|---|
| product | D10 (μm)* | D50 (μm)* | D90 (μm)* |
| Resistant dextrin | 13.9 | 36.3 | 72 |
| fiber (CSF) | | | |
| Micronized wheat | 2.6 | 7.9 | 17.4 |
| bran (MWB) | | | |
| Corn fiber (CF) | 2.4 | 9.4 | 23.6 |
| Sun flower meal | 1.7 | 7.3 | 26.0 |
| (SFM) | | | |
| Co-dried MWB/CSF | 5.0 | 17.8 | 71.9 |
| (sample 1) | | | |
| Co-dried CF/CSF | 4.6 | 14.2 | 30.4 |
| (sample 2) | | | |
| Co-dried SFM/CSF | 5.1 | 15.1 | 60.4 |
| (sample 3) | | | |

*The particle size distributions refer to percentage by volume

### Microscopic Structures

Moreover, the co-dried samples 1 to 3 were assessed via electron microscopy and compared with soluble fibers, insoluble fibers, and dry blends of insoluble/soluble fibers.

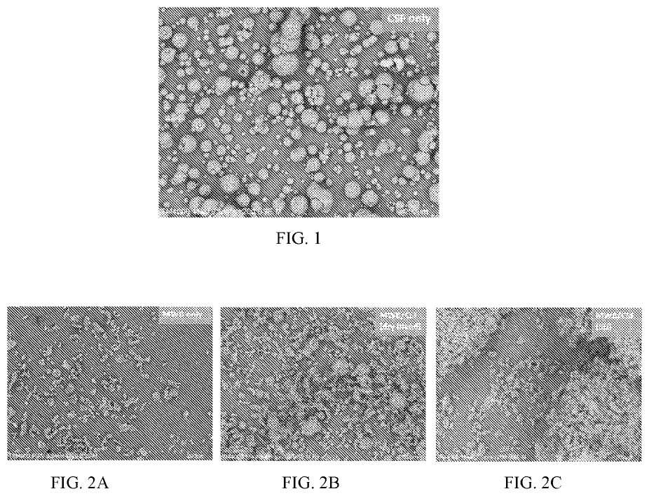

In this regard, dry blends of insoluble/soluble fibers were prepared by the mere dry blending of the corresponding insoluble fibers and soluble fibers in the same amounts as given in samples 1 to 3 (i.e., the soluble fibers and the insoluble fibers in the dry blends were not dried at the same time). This allows assessing whether the preparation process of the co-dried samples has any effect on the structure of the co-dried samples as compared to the mere dry blending of the insoluble fibers and soluble fibers. The results are shown in FIGS. 1-4.

As shown in FIG. 1, CSF particles appear to have a substantially spherical morphology.

From FIGS. 1 and 2A to 2C, it can be observed that the dry blending of MWB/CSF merely results in loose CSF particles and loose MWB particles (with MWB particles appearing to have a flake-like morphology), in which MWB particles are not coated with CSF particles. By contrast, the co-dried MWB/CSF sample (sample 1) led to a combination of particles including loose CSF particles, loose MWB particles, and MWB particles coated with CSF particles to form clusters of coated particles. It can also be observed that the co-dried sample 1 showed a smoother surface structure compared to the insoluble fiber alone (MWB).

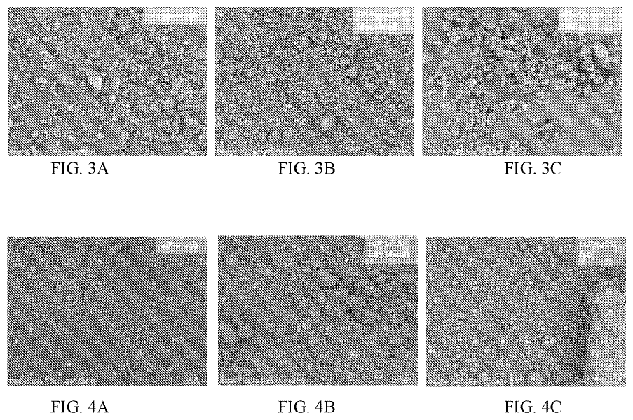

Likewise, from FIGS. 1 and 3A to 3C, it can be observed that the dry blending of CF/CSF merely results in loose CSF particles and loose CF particles (with CF particles appearing to have a flak-like morphology), in which CF particles are not coated with CSF particles. By contrast, the co-dried CF/CSF sample (sample 2) led to a combination of particles including loose CSF particles, loose CF particles, and CF particles coated with CSF particles to form clusters of coated particles. It can also be observed that the co-dried sample 2 showed a smoother surface structure compared to the insoluble fiber alone (CF).

Likewise, from FIGS. 1 and 4A to 4C, it can be observed that the dry blending of SFM/CSF merely results in loose CSF particles and loose SFM particles (with SFM particles appearing to have a granular morphology), in which SFM particles are not coated with CSF particles. By contrast, the co-dried SFM/CSF sample (sample 3) led to a combination of particles including loose CSF particles, loose SFM particles, and SFM particles coated with CSF particles to form clusters of coated particles. It can also be observed that the co-dried sample 3 showed a smoother surface structure compared to the insoluble fiber alone (SFM).

### Oil Binding Capacity Evaluation

The oil binding capacity (OBC) of the co-dried product samples 1 and 2 were measured and compared with the oil binding capacity of corresponding insoluble fibers and dry blends of insoluble/soluble fibers.

The oil binding capacity was measured as follows:
A suspension of the sample to be tested in soya oil was prepared (W1=2.5 g was the amount of the tested sample, and W2=50 g was the amount of soya oil).
The mixture was stirred for 10 minutes at 500 rpm until the sample had been completely dispersed.
The mixture was allowed to stand at room temperature for 30 minutes.
The dispersion was stirred and a tube was filled with 45 g of the product-in-oil dispersion in a tube. The weight of the tube before filling was noted as W3, and the weight of the tube after filling was noted as W4.
The tube was centrifuged for 5 minutes at 3800 rpm with a Sorvall Automatic centrifuge SS-3.
The supernatant was decanted and the weight of the centrifuge tube containing the precipitate was noted as W5.

The OBC is then calculated by the following formula:

OBC=W_{CO}/W_{CP},
wherein Wₚ is the percentage amount of product in the start oil mixture: Wₚ=W1×100/(W1+W2);
wherein W_{O} is the percentage amount of oil in the start oil mixture: W_{O}=W2×100/(W1+W2);
wherein W_{CP} is the product weight: W_{CP}=(Wₚ/100)×(W4−W3); and
wherein W_{CO} is the oil bind: W_{CO}=W5−W3−W_{CP}.

The results of the OBC measurements are given in Table 3 below.

TABLE 3
OBC of co-dried samples 1 to 3, insoluble fibers, and
dry blends of insoluble/soluble fibers.

| Type of fiber product | OBC (g oil/g sample) |
|---|---|
| Micronized wheat bran | 1.68 |
| (MWB) | |
| Dry blend (MWB/CSF) | 1.40 |
| Co-dried MWB/CSF | 1.22 |
| (sample 1) | |
| Corn fiber (CF) | 1.60 |
| Dry blend (CF/CSF) | 1.38 |
| Co-dried CF/CSF | 1.26 |
| (sample 2) | |
| Sun flower meal (SFM) | 1.42 |
| Dry blend (SFM/CSF) | 1.14 |
| Co-dried SFM/CSF | 1.31 |
| (sample 3) | |

From Table 3 it can be observed that the co-dried fiber product samples 1 to 3 show a lower OBC as compared to corresponding insoluble fibers.

### Example 2—Preparation of Food Products Comprising Co-Dried Fiber Products of the Present Invention

Co-dried fiber product samples 4 to 6 were prepared using the preparation process described in Example 1. Compositions of samples 4 to 6 are shown in Table 4 below.

TABLE 4
Compositions of co-dried fiber product samples 4 to 6.

| | Sample 4 | Sample 5 | Sample 6 |
|---|---|---|---|
| Insoluble | Micronized wheat | Corn fiber | Sun flower meal |
| fiber (IF) | bran (MWB) | (CF) | (SFM) |
| | (Cargill) | (Fibrogem | (LoPro from |
| | | B+ from | Cargill) |
| | | Cargill) | |
| Soluble | Resistant | Resistant | Resistant dextrin |
| fiber (SF) | dextrin fiber | dextrin fiber | fiber |
| | (CSF L80 from | (CSF L80 from | (CSF L80 from |
| | Cargill) | Cargill) | Cargill) |
| Dry weight ratio | 50:50 | 50:50 | 50:50 |
| soluble fibers to | | | |
| insoluble fibers | | | |

### Recipes and Nutritional Profile of Chocolate Products

A reference chocolate product without any soluble or insoluble fibers was prepared according to the recipe in Table 5. Nutritional profile of the reference chocolate product is shown in Table 6.

TABLE 5
Recipe for reference chocolate product.

| | In wt. % of the total weight of the |
|---|---|
| Ingredients | chocolate product |
| Cocoa powder | 9.5 |
| (Cargill) | |
| Fluid lecithin | 0.5 |
| (Cargill) | |
| Icing sugar | 47.9 |
| (Sudzucker) | |
| Natural vanilla flavour | 0.1 |
| (Prova) | |
| Palm coconut blend | 32.0 |
| (Cargill) | |
| Skimmed milk powder | 10.0 |
| (Fabelco) | |

TABLE 6
Nutritional profile for reference chocolate product.
SAFA stands for saturated fatty acids.

| Nutritional profile | |
|---|---|
| Energy (kcal) | 548.61 |
| Carbohydrates (in wt. %) | 54.14 |
| of which sugars (in wt. %) | 53.22 |
| Fat (in wt. %) | 33.62 |
| Of which SAFA (in | 21.58 |
| wt. %) | |
| Protein (in wt. %) | 5.39 |
| Salt (in wt. %) | 0.11 |
| Fiber (in wt. %) | 2.95 |

Tables 7 to 10 show the recipes upon which chocolate products using co-dried fiber product sample 4 (MWB/CSF) and its respective insoluble fibers (MWB) were prepared, and the nutritional profiles of such chocolate products.

TABLE 7
Recipe for chocolate product using co-dried
fiber product sample 4 (MWB/CSF).

| | In wt. % of the total weight |
|---|---|
| Ingredients | of the chocolate product |
| Cocoa powder | 9.5 |
| (Cargill) | |
| Fluid lecithin | 0.5 |
| (Cargill) | |
| Icing sugar | 29.5 |
| (Sudzucker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| MWB/CSF | 18.4 |
| (Cargill) | |

TABLE 8
Nutritional profile for chocolate product using co-dried fiber
product sample 4 (MWB/CSF). SAFA stands for saturated
fatty acids.

| Nutritional profile | |
|---|---|
| Energy (kcal) | 521.65 |
| Carbohydrates (in wt. %) | 39.51 |
| of which sugars (in wt. %) | 35.74 |
| Fat (in wt. %) | 34.08 |
| Of which SAFA (in | 21.58 |
| wt. %) | |
| Protein (in wt. %) | 6.77 |
| Salt (in wt. %) | 0.11 |
| Fiber (in wt. %) | 14.63 |

TABLE 9
Recipe for chocolate product using MWB.

| | In wt. % of the total |
|---|---|
| | weight of the |
| Ingredients | chocolate product |
| Cocoa powder | 9.5 |
| (Cargill) | |
| Fluid lecithin | 0.5 |
| (Cargill) | |
| Icing sugar | 30.1 |
| (Sudzücker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| MWB | 17.8 |
| (Cargill) | |

TABLE 10
Nutritional profile for chocolate product using MWB.
SAFA stands for saturated fatty acids.

| Nutritional profile | |
|---|---|
| Energy (kcal) | 527.42 |
| Carbohydrates (in wt. %) | 40.43 |
| of which sugars (in wt. %) | 35.96 |
| Fat (in wt. %) | 34.51 |
| Of which SAFA (in | 21.58 |
| wt. %) | |
| Protein (in wt. %) | 8.06 |
| Salt (in wt. %) | 0.11 |
| Fiber (in wt. %) | 11.85 |

Tables 11 to 14 show the recipes upon which chocolate products using co-dried fiber product sample 5 (CF/CSF) and its respective insoluble fibers (CF) were prepared, and the nutritional profiles of such chocolate products.

TABLE 11
Recipe for chocolate product using co-dried fiber
product sample 5 (CF/CSF).

| | In wt. % of the total |
|---|---|
| | weight of the |
| Ingredients | chocolate product |
| Cocoa powder | 9.5 |
| (Cargill) | |
| Fluid lecithin | 0.5 |
| (Cargill) | |
| Icing sugar | 29.9 |
| (Sudzücker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| CF/CSF | 18.0 |
| (Cargill) | |

TABLE 12
Nutritional profile for chocolate product using co-dried fiber
product sample 5 (CF/CSF). SAFA stands for saturated
fatty acids.

| Nutritional profile | |
|---|---|
| Energy (kcal) | 518.55 |
| Carbohydrates (in wt. %) | 38.75 |
| of which sugars (in wt. %) | 35.85 |
| Fat (in wt. %) | 33.89 |
| Of which SAFA (in | 21.58 |
| wt. %) | |
| Protein (in wt. %) | 6.29 |
| Salt (in wt. %) | 0.11 |
| Fiber (in wt. %) | 15.82 |

TABLE 13
Recipe for chocolate product using CF.

| | In wt. % of the total |
|---|---|
| | weight of the |
| Ingredients | chocolate product |
| Cocoa powder | 9.5 |
| (Cargill) | |
| Fluid lecithin | 0.5 |
| (Cargill) | |
| Icing sugar | 30.6 |
| (Sudzücker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| CF | 17.3 |
| (Cargill) | |

TABLE 14
Nutritional profile for chocolate product using CF.
SAFA stands for saturated fatty acids.

| Nutritional profile | |
|---|---|
| Energy (kcal) | 520.93 |
| Carbohydrates (in wt. %) | 38.74 |
| of which sugars (in wt. %) | 35.92 |
| Fat (in wt. %) | 34.14 |
| Of which SAFA (in | 21.58 |
| wt. %) | |
| Protein (in wt. %) | 7.12 |
| Salt (in wt. %) | 0.11 |
| Fiber (in wt. %) | 14.36 |

Tables 15 to 18 show the recipes upon which chocolate products using co-dried fiber product sample 6 (SFM/CSF) and its respective insoluble fibers (SFM) were prepared, and the nutritional profiles of such chocolate products.

TABLE 15
Recipe for chocolate product using co-dried fiber
product sample 6 (SFM/CSF).

| | In wt. % of the total |
|---|---|
| | weight of the |
| Ingredients | chocolate product |
| Cocoa powder | 9.5 |
| (Cargill) | |
| Fluid lecithin | 0.5 |
| (Cargill) | |
| Icing sugar | 29.5 |
| (Sudzücker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| SFM/CSF | 18.4 |
| (Cargill) | |

TABLE 16
Nutritional profile for chocolate product using co-dried fiber
product sample 6 (SFM/CSF). SAFA stands for saturated
fatty acids.

| Nutritional profile | |
|---|---|
| Energy (kcal) | 517.88 |
| Carbohydrates (in wt. %) | 37.39 |
| of which sugars (in wt. %) | 36.03 |
| Fat (in wt. %) | 33.71 |
| Of which SAFA (in | 21.58 |
| wt. %) | |
| Protein (in wt. %) | 8.37 |
| Salt (in wt. %) | 0.11 |
| Fiber (in wt. %) | 14.17 |

TABLE 17
Recipe for chocolate product using SFM.

| | In wt. % of the total |
|---|---|
| | weight of the |
| Ingredients | chocolate product |
| Cocoa powder | 9.5 |
| (Cargill) | |
| Fluid lecithin | 0.5 |
| (Cargill) | |
| Icing sugar | 29.5 |
| (Sudzücker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| SFM | 18.4 |
| (Cargill) | |

TABLE 18
Nutritional profile for chocolate product using SFM.
SAFA stands for saturated fatty acids.

| Nutritional profile | |
|---|---|
| Energy (kcal) | 519.17 |
| Carbohydrates (in wt. %) | 35.74 |
| of which sugars (in wt. %) | 35.94 |
| Fat (in wt. %) | 33.81 |
| Of which SAFA (in | 21.58 |
| wt. %) | |
| Protein (in wt. %) | 11.34 |
| Salt (in wt. %) | 0.11 |
| Fiber (in wt. %) | 11.23 |

A chocolate product using soluble fibers (CSF) was prepared according to the recipe in Table 19. Nutritional profile of such chocolate product is shown in Table 20.

TABLE 19
Recipe for chocolate product using CSF.

| | In wt. % of the total |
|---|---|
| | weight of the |
| Ingredients | chocolate product |
| Cocoa powder | 9.5 |
| (Cargill) | |
| Fluid lecithin | 0.5 |
| (Cargill) | |
| Icing sugar | 29.2 |
| (Sudzücker) | |
| Natural vanilla flavour | 0.1 |
| (Prova) | |
| Palm coconut blend | 32.0 |
| (Cargill) | |
| Skimmed milk powder | 10.0 |
| (Fabelco) | |
| CSF | 18.7 |
| (Cargill) | |

TABLE 20
Nutritional profile for chocolate product using CSF.
SAFA stands for saturated fatty acids.

| Nutritional profile | |
|---|---|
| Energy (kcal) | 516.07 |
| Carbohydrates (in wt. %) | 38.80 |
| of which sugars (in wt. %) | 35.83 |
| Fat (in wt. %) | 33.62 |
| Of which SAFA (in wt. %) | 21.58 |
| Protein (in wt. %) | 5.39 |
| Salt (in wt. %) | 0.11 |
| Fiber (in wt. %) | 17.35 |

### Rheology Analysis

The rheological properties of some of the chocolate products prepared according to recipes in Tables 5 to 20 were assessed. Yield stress and viscosity were measured with a MCR 51 or MCR 72 instrument (from Anton Paar) showing a CC27 or C-CC39/T200/XL cylinder. The measurement of the rheological parameters was conducted according to the IOCCC2000 standard at a temperature of 40 °C and at a pre-shear rate of 5 s⁻¹ for 60 s, a shear rate-ramp from 2 s⁻¹ to 50 s⁻¹ for 180 s, a holding phase of 60 s at a shear rate of 50 s⁻¹, and a shear rate-ramp from 50 s⁻¹ to 2 s⁻¹ for 180 s. Data analysis/calculation was made with the Casson method.

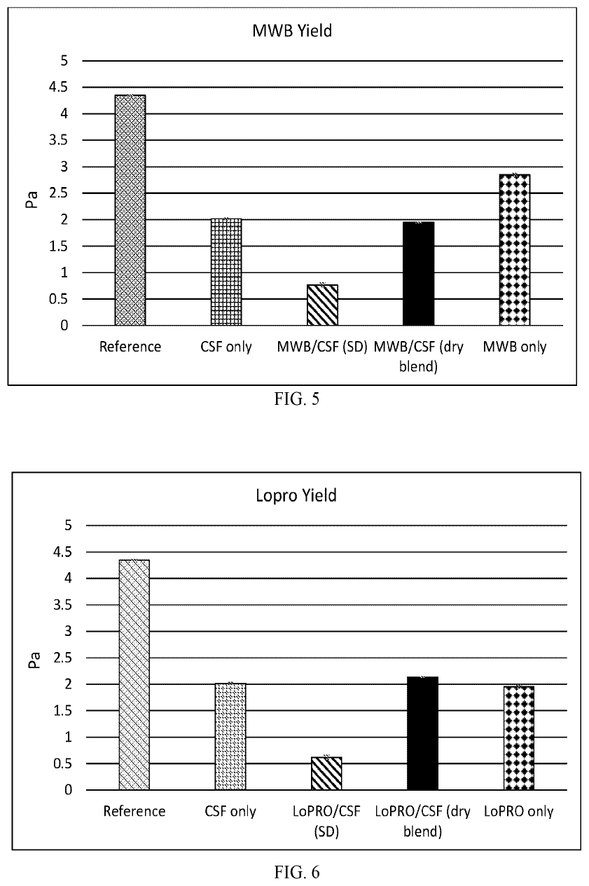

The results of the conducted yield stress measurements are shown in FIGS. 5 and 6, and Table 21.

In FIG. 5, the yield stress is compared between the reference chocolate product (reference), the chocolate product comprising soluble fiber only (CSF only), the chocolate product comprising the co-dried fiber product sample 4 (MWB/CSF (SD)), the chocolate product comprising the dry blend of the insoluble/soluble fibers (MWB/CSF (dry blend)), and the reference chocolate product comprising insoluble fiber only (MWB only). The lowest yield stress value was observed for the chocolate product comprising the co-dried fiber product sample 4 (MWB/CSF (SD)).

Dry blends of insoluble/soluble fibers were prepared by the mere dry blending of the corresponding insoluble fibers and soluble fibers in the dry weight ratios as given in samples 4 to 6 (i.e., the soluble fibers and the insoluble fibers in the dry blends were not dried at the same time).

In FIG. 6, the yield stress is compared between the reference chocolate product (reference), the chocolate product comprising soluble fiber only (CSF only), the chocolate product comprising the co-dried fiber product sample 6 (LoPRO/CSF (SD)), the chocolate product comprising the dry blend of the insoluble/soluble fibers (LoPRO/CSF (dry blend)), and the reference chocolate product comprising insoluble fiber only (LoPRO only). The lowest yield stress value was observed for the chocolate product comprising the co-dried fiber product sample 6 (LoPRO/CSF (SD)).

TABLE 21
Yield stresses of chocolate products.

| Type of chocolate product | Yield stress (Pa) |
|---|---|
| Reference | 4.35 |
| Soluble fiber (CSF only) | 2.01 |
| Co-dried MWB/CSF | 0.77 |
| (sample 4) | |
| Dry blend MWB/CSF | 1.95 |
| MWB only | 2.85 |
| Co-dried CF/CSF | 0.62 |
| (sample 5) | |
| Dry blend CF/CSF | 0.69 |
| CF only | 0.53 |
| Co-dried SFM/CSF | 0.62 |
| (sample 6) | |
| Dry blend SFM/CSF | 2.14 |
| SFM only | 1.96 |

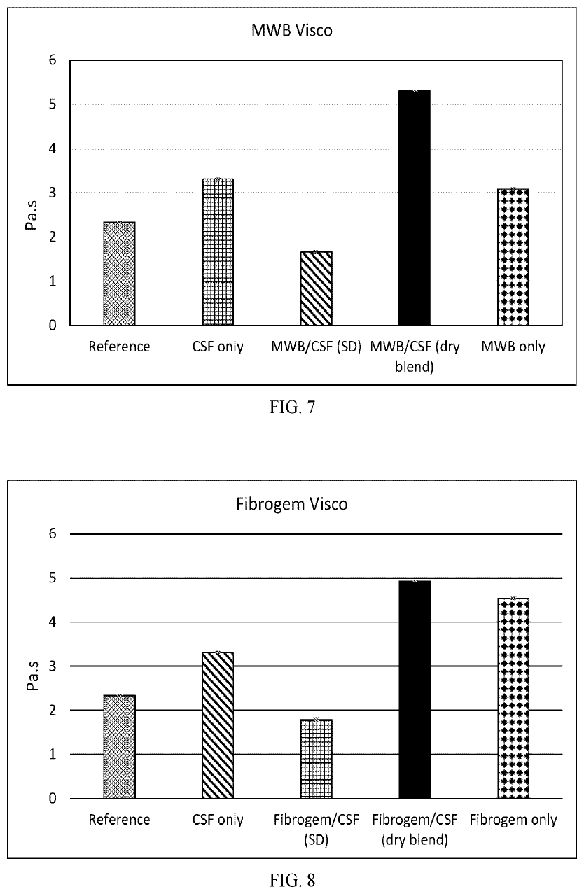

The results of the conducted viscosity measurements are shown in FIGS. 7 and 8, and Table 22.

In FIG. 7, the viscosity is compared between the reference chocolate product (reference), the chocolate product comprising soluble fiber only (CSF only), the chocolate product comprising the co-dried fiber product sample 4 (MWB/CSF (SD)), the chocolate product comprising the dry blend of the insoluble/soluble fibers (MWB/CSF (dry blend)), and the reference chocolate product comprising insoluble fiber only (MWB only). The lowest viscosity stress value was observed for the chocolate product comprising the co-dried fiber product sample 4 (MWB/CSF (SD)).

In FIG. 8, the viscosity is compared between the reference chocolate product (reference), the chocolate product comprising soluble fiber only (CSF only), the chocolate product comprising the co-dried fiber product sample 5 (Fibrogem/CSF (SD)), the chocolate product comprising the dry blend of the insoluble/soluble fibers (Fibrogem/CSF (dry blend)), and the reference chocolate product comprising insoluble fiber only (Fibrogem only). The lowest viscosity stress value was observed for the chocolate product comprising the co-dried fiber product sample 5 (Fibrogem/CSF (SD)).

TABLE 22
Viscosities of chocolate products.

| Type of chocolate product | Viscosity (Pa.s) |
|---|---|
| Reference | 2.34 |
| Soluble fiber (CSF only) | 3.32 |
| Co-dried MWB/CSF | 1.66 |
| (sample 4) | |
| Dry blend MWB/CSF | 5.30 |
| MWB only | 3.08 |
| Co-dried CF/CSF | 1.79 |
| (sample 5) | |
| Dry blend CF/CSF | 4.93 |
| CF only | 4.54 |
| Co-dried SFM/CSF | 5.67 |
| (sample 6) | |
| Dry blend SFM/CSF | 4.68 |
| SFM only | 8.23 |

### Sensory Evaluation

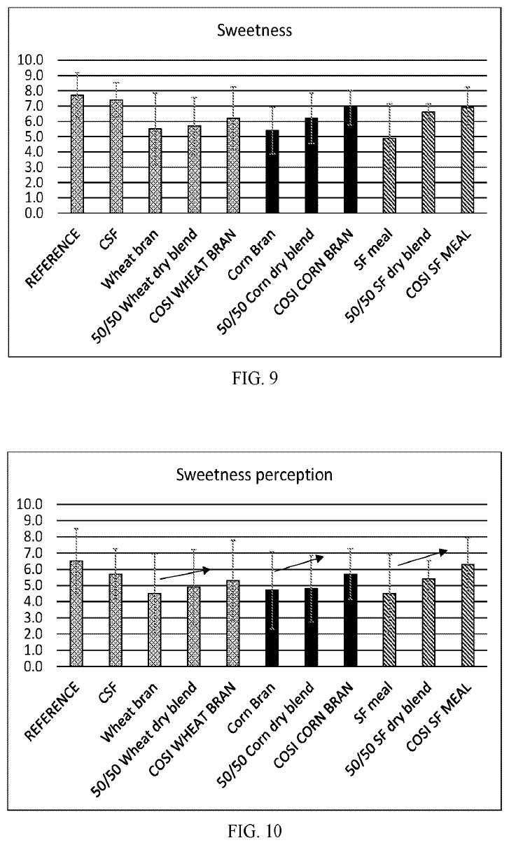

Sensorial evaluations of the prepared chocolate products were conducted, with regard to sweetness, sweetness perception, and off-taste. The results are shown in FIGS. 9 to 11.

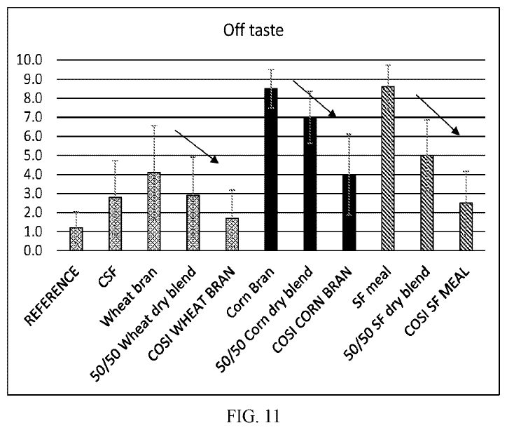

From FIGS. 9 and 10, it can be observed that the chocolate products comprising the co-dried fiber product samples 4 to 6 (referred to as COSI wheat bran/corn bran/SF meal respectively in FIGS. 9 and 10) showed more pronounced sweetness and sweetness perception as compared to the respective insoluble fibers and the dry blends of insoluble/soluble fibers. Moreover, as shown in FIG. 11, the chocolate products comprising the co-dried fiber product samples 4 to 6 also showed less off-tastes as compared to the use of the respective insoluble fibers and the dry blends of soluble/insoluble fibers.

Again, dry blends of insoluble/soluble fibers were prepared by the mere dry blending of the corresponding insoluble fibers and soluble fibers in the dry weight ratios as given in samples 4 to 6 (i.e., the soluble fibers and the insoluble fibers in the dry blends were not dried at the same time).

### Clauses Describing the Invention

Clause 1. A co-dried fiber product comprising soluble fibers and insoluble fibers, wherein the insoluble fibers are partially or fully coated with soluble fibers.
Clause 2. The co-dried fiber product of clause 1, wherein the soluble fibers and the insoluble fibers are co-dried together such that the insoluble fibers are partially or fully coated with the soluble fibers.
Clause 3. The co-dried fiber product of any of the preceding clauses, wherein at least a portion of the insoluble fibers are partially or fully coated with the soluble fibers.
Clause 4. The co-dried fiber product of any of the preceding clauses, having:
   a D10 of less than 10 μm, preferably in a range of from 1 to 10 μm, more preferably in a range of from 3 to 8 μm;
   a D50 of less than 60 μm, preferably in a range of from 1 to 60 μm, more preferably in a range of from 10 to 30 μm; and/or
   a D90 of less than 150 μm, preferably in a range of from 20 to 150 μm, more preferably in a range of from 30 μm to 80 μm.
Clause 5. The co-dried fiber product of any of the preceding clauses, wherein the oil binding capacity of the co-dried fiber product is from 0.7 to 1.45 g oil/g of co-dried fiber product, preferably from 0.9 to 1.35 g oil/g of co-dried fiber product, more preferably from 1.1 to 1.35 g oil/g of co-dried fiber product.
Clause 6. The co-dried fiber product of any of the preceding clauses, wherein the oil binding capacity of the co-dried fiber product is decreased by 1 to 50% as compared to the insoluble fiber particles, preferably by 3 to 40% as compared to the insoluble fiber particles, more preferably by 5 to 30% as compared to the insoluble fiber particles.
Clause 7. The co-dried fiber product of any of the preceding clauses, wherein the soluble fiber is selected from the group consisting of resistant dextrin, resistant or modified maltodextrin, polydextrose, β-glucan, galactomannan, fructo-oligosaccharides, gluco-oligosaccharide, galacto-oligosaccharides, manno-oligosaccharides, pectin, psyllium, inulin, resistant starch, xylo-oligosaccharides, and any combinations thereof.
Clause 8. The co-dried fiber product of any of the preceding clauses, wherein the insoluble fiber is selected from the group consisting of dietary fibers, corn fibers, sun flower meals, cereal brans, oat fibers, bamboo fibers, fruit fibers, sugar beet fibers, sugar cane fibers, tomato fibers, coconut fibers, straws from cereals such as wheat or barley, pea fiber, tea, coffee, potato fiber, cocoa, cocoa powder, bran waste, sugar waste, cocoa waste, corn-cob waste, cellulose, hemi-cellulose, chitosan, pectins, gums, mucilages, lignins, and any combinations thereof.
Clause 9. A method of preparing a co-dried fiber product of any of clauses 1 to 8, comprising the steps of:
   (a) mixing soluble fiber particles and insoluble fiber particles in a dry weight ratio of from 20:80 to 80:20, preferably from 30:70 to 70:30, more preferably from 40:60 to 60:40, even more preferably of 50:50, in water to obtain a suspension;
   (b) drying the suspension, preferably by spray-drying, to obtain a co-dried fiber product; and
   (c) optionally adding one or more of the following to the co-dried fiber product:
      i. flavoring agents;
      ii. emulsifying agents;
      iii. coloring agents; and
      iv. anticaking agents;
   wherein the insoluble fiber particles are partially or fully coated with the soluble fiber particles in the co-dried fiber product.
Clause 10. The method according to clause 9, wherein the drying step is performed by spray-drying and wherein an inlet temperature of a spray dryer is from 130 to 180 °C, preferably from 140 to 170 °C, more preferably from 150 to 160 °C, and wherein an outlet temperature of the spray dryer is from 70 to 100 °C, preferably from 80 to 90 °C.
Clause 11. The method of any of clauses 9 to 10, wherein the mixing step further comprises steps of:
   (d) dissolving soluble fiber particles with water having a temperature of from 5 to 95 °C, preferably from 30 to 85 °C, more preferably from 60 to 80 °C, to form a soluble fiber solution; and
   (e) adding insoluble fiber particles into the soluble fiber solution to obtain the suspension of soluble fiber particles and insoluble fiber particles.
Clause 12. The method of any of clauses 9 to 11, wherein the mixing step and the drying step can be carried out in one single step.
Clause 13. The method of any of clauses 9 to 12, wherein any two or more of the steps of the method occur simultaneously, sequentially, or non-sequentially.
Clause 14. A co-dried fiber product obtainable by the method of any of clauses 9 to 13.
Clause 15. A fat-based food or feed product comprising the co-dried fiber product of any of clauses 1 to 8.
Clause 16. The fat-based food or feed product of clause 15, wherein the co-dried fiber product according to any of claims 1 to 8 is present in an amount of from 1 to 25 wt. %, preferably from 5 to 23 wt. %, more preferably from 10 to 22 wt. %, even more preferably from 15 to 20 wt. %, based on the total weight of the fat-based food or feed product.
Clause 17. The fat-based food or feed product of any of clauses 15 to 16, wherein the yield stress of the fat-based food or feed product is from 0.3 to 15 Pa, preferably from 0.4 to 10 Pa, more preferably from 0.5 to 5 Pa.
Clause 18. The fat-based food or feed product of any of clauses 15 to 17, wherein the viscosity of the fat-based food or feed product is from 0.5 to 2.5 Pa·s, preferably from 0.8 to 2.2 Pa·s, more preferably from 1.0 to 2.0 Pa·s.
Clause 19. Use of a co-dried fiber product of any of clauses 1 to 8 as a bulking agent or sugar replacement in a fat-based food or feed product.

1. A co-dried fiber product comprising soluble fibers and insoluble fibers, wherein the insoluble fibers are partially or fully coated with soluble fibers.

2. The co-dried fiber product according to claim 1, wherein the soluble fibers and the insoluble fibers are co-dried together such that the insoluble fibers are partially or fully coated with the soluble fibers.

3. The co-dried fiber product according to claim 1, wherein at least a portion of the insoluble fibers are partially or fully coated with the soluble fibers.

4. The co-dried fiber product according to claim 1, having:
a D10 of less than 10 μm, preferably in a range of from 1 to 10 μm, more preferably in a range of from 3 to 8 μm;
a D50 of less than 60 μm, preferably in a range of from 1 to 60 μm, more preferably in a range of from 10 to 30 μm; and/or
a D90 of less than 150 μm, preferably in a range of from 20 to 150 μm, more preferably in a range of from 30 μm to 80 μm.

5. The co-dried fiber product according to claim 1, wherein the oil binding capacity of the co-dried fiber product is from 0.7 to 1.45 g oil/g of co-dried fiber product, preferably from 0.9 to 1.35 g oil/g of co-dried fiber product, more preferably from 1.1 to 1.35 g oil/g of co-dried fiber product.

6. The co-dried fiber product according to claim 1, wherein the oil binding capacity of the co-dried fiber product is decreased by 1 to 50% as compared to the insoluble fiber particles, preferably by 3 to 40% as compared to the insoluble fiber particles, more preferably by 5 to 30% as compared to the insoluble fiber particles.

7. The co-dried fiber product according to claim 1, wherein the soluble fiber is selected from the group consisting of resistant dextrin, resistant or modified maltodextrin, polydextrose, β-glucan, galactomannan, fructo-oligosaccharides, gluco-oligosaccharide, galacto-oligosaccharides, manno-oligosaccharides, pectin, psyllium, inulin, resistant starch, xylo-oligosaccharides, and any combinations thereof; and/or
the insoluble fiber is selected from the group consisting of dietary fibers, corn fibers, sun flower meals, cereal brans, oat fibers, bamboo fibers, fruit fibers, sugar beet fibers, sugar cane fibers, tomato fibers, coconut fibers, straws from cereals such as wheat or barley, pea fiber, tea, coffee, potato fiber, cocoa, cocoa powder, bran waste, sugar waste, cocoa waste, corn-cob waste, cellulose, hemi-cellulose, chitosan, pectins, gums, mucilages, lignins, and any combinations thereof.

8. A method of preparing a co-dried fiber product according to claim 1, comprising the steps of:
(a) mixing soluble fiber particles and insoluble fiber particles in a dry weight ratio of from 20:80 to 80:20, preferably from 30:70 to 70:30, more preferably from 40:60 to 60:40, even more preferably of 50:50, in water to obtain a suspension;
(b) drying the suspension, preferably by spray-drying, to obtain a co-dried fiber product; and
(c) optionally adding one or more of the following to the co-dried fiber product:
i. flavoring agents;
ii. emulsifying agents;
iii. coloring agents; and
iv. anticaking agents;
wherein the insoluble fiber particles are partially or fully coated with the soluble fiber particles in the co-dried fiber product.

9. The method according to claim 8, wherein the drying step is performed by spray-drying and wherein an inlet temperature of a spray dryer is from 130 to 180 °C, preferably from 140 to 170 °C, more preferably from 150 to 160 °C, and wherein an outlet temperature of the spray dryer is from 70 to 100 °C, preferably from 80 to 90 °C.

10. The method according to claim 8, wherein the mixing step further comprises steps of:
(d) dissolving soluble fiber particles with water having a temperature of from 5 to 95 °C, preferably from 30 to 85 °C, more preferably from 60 to 80 °C, to form a soluble fiber solution; and
(e) adding insoluble fiber particles into the soluble fiber solution to obtain the suspension of soluble fiber particles and insoluble fiber particles.

11. The method according to claim 8, wherein the mixing step and the drying step can be carried out in one single step; and/or
any two or more of the steps of the method occur simultaneously, sequentially, or non-sequentially.

12. A co-dried fiber product obtainable by the method according to claim 8.

13. A fat-based food or feed product comprising the co-dried fiber product according to claim 1.

14. The fat-based food or feed product according to claim 13, wherein the co-dried fiber product according to claim 1 is present in an amount of from 1 to 25 wt. %, preferably from 5 to 23 wt. %, more preferably from 10 to 22 wt. %, even more preferably from 15 to 20 wt. %, based on the total weight of the fat-based food or feed product; and/or
the yield stress of the fat-based food or feed product is from 0.3 to 15 Pa, preferably from 0.4 to 10 Pa, more preferably from 0.5 to 5 Pa; and/or
the viscosity of the fat-based food or feed product is from 0.5 to 2.5 Pa·s, preferably from 0.8 to 2.2 Pa·s, more preferably from 1.0 to 2.0 Pa·s.

15. Use of a co-dried fiber product according to claim 1 as a bulking agent or sugar replacement in a fat-based food or feed product.
